(19) United States
(12) Patent Application Publication
(10) Pub. No.: US 2026/0219515 A1
(43) Pub. Date: Jul. 30, 2026

(54) A SYNERGISTIC PAIR OF MULTIFOCAL DIFFRACTIVE OCULAR LENSES

(71) Applicant: VSY Biyoteknoloji ve Ilac Sanayi A.S., Tuzla/Istanbul (TR)

(72) Inventors: Sven Thage Sigvard HOLMSTROM, Tuzla/Istanbul (TR); Amin TABATABAEI MOHSENI, Tuzla/Istanbul (TR); Efe CAN, Tuzla/Istanbul (TR)

(73) Assignee: VSY Biyoteknoloji ve Ilac Sanayi A.S., Tuzla/Istanbul (TR)

(21) Appl. No.: 19/144,794

(22) PCT Filed: Dec. 30, 2022
(86) PCT No.: PCT/TR2022/051740

§ 371 Date: Jun. 30, 2025

(51) Int. Cl. G02C 7/04

(52) U.S. Cl. CPC G02C 7/042; G02C 2202/08; G02C 2202/20

(57) ABSTRACT

An assembly comprising a pair of multifocal ocular aphakic lenses to be worn simultaneously by a user is proposed. Said lenses having a light transmissive lens body with an optical axis and a refractive baseline extending over at least part of the lens body, and a diffractive profile operating as an optical wave splitter extends concentrically in radial direction, superpositioned onto at least part of the refractive baseline. Both lenses comprise diffractive profile in the central 4 millimeters without discontinuities, with useful diffractive orders on both sides of 0^{th} diffractive order. Both lenses also comprise a lowest usable diffraction order providing far vision, a highest usable diffraction order providing near vision, light intensity of near vision being higher than that of any diffraction order between the highest and lowest usable orders for lens apertures between 2-3 millimeters.

### TECHNICAL FIELD OF THE PRESENT INVENTION

The present disclosure relates to ophthalmic lenses, including contact and intra-ocular multifocal lenses. These lenses utilize a smooth diffractive structure to provide multifocality without discontinuities. The diffractive pattern is achieved through the assembly of two lenses with different patterns, arranged in a way that optimizes human vision under various light conditions and pupil sizes.

### BACKGROUND OF THE PRESENT INVENTION

Diffractive lenses for ophthalmological applications are constructed as hybrid lenses with a diffractive pattern added onto a refractive body. Often one aspect of the lens is purely refractive, while the other aspect has a diffractive grating superpositioned over a refractive base line. The refractive baseline can be spherical, or alternatively have an aspherical shape. The diffractive part can in general be applied to any of the two sides of the lens, since when a diffractive pattern is to be combined with a refractive surface with some special feature it generally does not matter if they are added to the same side or if one is added to a first side and the other to a second side of the lens. Concurrently, two diffractive patterns may be combined either by super positioning on one side, or by adding them on separate sides in an overlapping fashion. The optical power of the lens for a specific diffraction order can be calculated by addition of the refractive base power and the optical power of that diffraction order.

The most well-researched type of diffraction lens proper is the monofocal phase-matched Fresnel lens as taught by Rossi et al. in their 1995 study titled “Refractive and diffractive properties of planar micro-optical elements”. This type of lens makes use of a sawtooth diffractive unit cell and a step height corresponding to a phase modulation of exactly 2π.

Recently, a greater focus in the industry and literature surrounding ophthalmic lenses with more than one single focal point has turned towards continuity of vision, rather than just two or three very sharp focal distances with sharp vision. One such idea has become more common than others, namely the enhanced depth-of-focus lens (EDOF) that tries to provide a fully continuous vision at at least photopic conditions and some mesopic conditions from far vision (the horizon) to intermediate vision (often measured at 66 cm distance from the eyes). However, it has been difficult to provide something similar for lenses that are fully multifocal, that also try to provide continuous vision from far to near vision (often measured at 40 cm).

Most diffractive multifocal lenses available in the market today are still ones that are based on a so-called “sawtooth” diffractive grating, where the 0^{th} order of said grating is utilized to provide far vision for a user. Far vision is generally configured to be the lowest power that is usable for the eye, so the order of the usable orders having the lowest power is generally assumed to be used for far vision. Whereas said sawtooth diffractive grating is the most light-efficient configuration for a strictly bifocal lens, this effect is not translated well into other multifocal lenses with higher numbers of foci. Most multifocal lenses with more than two foci still use a configuration where the 0^{th} order is utilized to provide far vision to the user akin to the case in sawtooth diffractive gratings, due to it being relatively easier to design a lens that provides high quality vision at the 0^{th} order. Far vision is usually prioritized, especially for intraocular lenses as surgical success is usually determined by the functionality of far vision.

However, recent progress has shown that several important advantages are associated with designing lenses that utilize an order other than the 0^{th} order for providing far vision, specifically those having useful orders simultaneously on both sides of the zeroth order. Specific sets of advantages arising from such designs differ between various types of possible configurations. As an example, binary diffractive lenses, utilizing typically −1^{st} order, +1st order as well as the 0^{th} order, contain fewer rings than corresponding trifocal sawtooth lenses, and have grating peaks that are less narrow, however retaining sharp transitions. Ophthalmic lenses based on binary grating and their advantages have been known for a long time, as demonstrated by WO1994011765A1. Such gratings can be either trifocal or bifocal, depending on the height of the structure. Symmetric sinusoidal diffractive gratings, i.e. sinusoidal diffractive gratings that have their orders evenly arranged around the 0^{th} order are the most light-efficient gratings possible for diffractive lenses with an odd number of usable focal points, as they avoid sharp transitions in the diffractive profile, increasing manufacturability, and biocompatibility. The latter point had originally been suggested in Osipov et al. in their 2015 study “Application of nanoimprinting technique for fabrication of trifocal diffractive lens with sine-like radial profile” as published in Journal of biomedical optics 20, no. 2 (2015): 025008. Diffractive profiles without discontinuities (sinusoidal lenses) have several very important advantages: They are less prone to produce undesired photic phenomena, such as halo and glare and other positive dysphotopsias, they are cheaper to manufacture well, they open up a wider set of manufacturing techniques, and they allow for continuous tuning of the light intensity distribution on a sub-period scale. For symmetric trifocal and pentafocal (lenses providing five diffraction orders) lenses this has been discussed in detail in WO2019020435A1 and WO2022177517A1.

Asymmetric diffractive lenses, that is lenses with a different number of usable orders on each side of the 0^{th} order can be advantageous. The asymmetric diffractive gratings have a smaller relative difference in power between the 0^{th} order and the order used for far vision, which can be used as an advantage. Having a far power closer to the zeroth order e.g. decreases undesired diopter offset in autorefractometry measurements, and the chromatic aberration caused by diffraction can be chosen to be smaller than in a lens with a symmetric grating. A sawtooth-like asymmetric diffractive lens is exemplified in WO2021245506. It features sharp vertical jumps and lacks a known way to tune the light distribution suitably as a function of the lens aperture. Increasing the number of diffractive orders increases the total potential light efficiency, e.g. an asymmetric diffractive lens having four orders can be more efficient than a symmetric lens utilizing three orders, an asymmetric lens having six orders can be more efficient than a corresponding symmetric lens using five orders. Increasing the number of diffractive orders also lead to fewer diffractive rings, which often means easier manufacturing.

Symmetric sinusoidal, continuous diffractive multifocal lenses can be found in the literature. WO2019020435A1 discloses a multifocal lens comprising a diffraction grating designed to operate as an optical wave splitter for distributing light incident at said lens body in said refractive and diffractive focal points. Said diffraction grating has an optical transfer function comprising a continuous periodic phase profile function extending in radial direction of the lens body. Said continuous periodic phase profile function also comprises an argument modulated as a function of radial distance to said optical axis of said lens body, thereby tuning said distributing of light incident at said lens body.

WO2022177517A1 discloses an ophthalmic multifocal lens with a light transmissive body with an optical axis and a refractive baseline extending over part of the body of the lens. It also discloses a first portion coinciding with a central area of said lens body and a multifocal second portion extending concentrically radially; said second portion further comprising a symmetric multifocal diffractive grating superpositioned onto said baseline, covering a portion of the lens, its shape and resulting light intensity distribution changing with distance to optical axis. In other words, this disclosure describes aperture-adaptive diffractive lenses with greater light efficiency and higher effective efficiency due to better adaption to the anatomy of the eye. It further describes a way to shape each period of the diffraction individually to provide at each aperture (and corresponding pupil size) the desired intensity distribution between e.g. far, intermediate, and near vision.

Multifocal ophthalmic lenses are often optimized to provide vision at two or three distances, arranged to coincide with far, intermediate, and near vision. This is mostly due vision being measured clinically at these specific distances. However, for the wellbeing of patients, especially those who want to be spectacle free, it is often better to provide more continuous vision.

However, all diffractive lenses provide an uneven intensity distribution. Not only the diffractive peaks proper are of importance, but different diffractive configurations bind the different diffractive orders together in different ways. With a given diffractive profile there tends to be one, or several, distances between the distinct focal points with very low light intensity. This has to some extent been addressed in the prior art.

U.S. Pat. No. 11,266,494B2 presents an assembly of a pair of lenses providing far vision and each with different additional asymmetric diffraction peaks arranged so that one lens has a higher Modulation Transfer Function Through Focus for intermediate vision than near, and for the other lens the opposite is true.

The solution in U.S. Pat. No. 11,266,494B2 gives specifically a solution for continuity between intermediate and near vision by combining two asymmetric peaks, one in each eye. However, we still lack a way to reliably attain continuous vision for the whole range from far through near. More importantly, the combination of two asymmetric peaks with different peak optical powers (one at intermediate and one at near) makes it impossible for both lenses to follow what the physiologically dictated design principles, as explained below.

The use of two lenses with slightly different optical goals for the two eyes of one patient is commonplace. A common practice in cataract surgery is for example monovision, where the vision in the dominant eye is corrected for distance vision, while the other eye is intentionally left somewhat nearsighted to provide some intermediate or near vision. Other combinations of lenses made on the surgeon's discretion is also well-know, where for example a monofocal lens corrected for far vision in the dominant eye is supplemented by a multifocal lens in the non-dominant eye. Even though this is known to work this is rarely supported well by products custom made for this practice, instead it is usually up to the surgeon to figure out which lenses are suitable for a so-called mix-and-match.

For a lens to provide vision enough for a user to be spectacle independent it needs to provide far, intermediate, and near vision. In photopic conditions, when small pupils are present a full multifocal vision is desired. Because of the well-known pinhole effect, causing a small pupil to provide a much higher depth of focus, small shifts in power for tiny pupils have no negative effect on vision. It is also this effect that allows some enhanced depth-of-focus lenses having all intermediate power centered around the optical axis, with higher intensity far power being provided for larger pupils. For very small pupils it can be acceptable to have a slightly weaker far vision.

In mesopic conditions with slightly larger pupils the pinhole effect is no longer in effect making it very important for multifocal lens intended for spectacle independence to provide a strong near vision in addition to far vision. For full spectacle independence intermediate vision is also desired.

Due to the accommodation reflex, human pupil constricts when viewing near objects, even in scotopic environments. Because of this, light focused for near vision at large pupils is physiologically not possible to use. Intermediate vision is much less afflicted by this problem, which on balance proves that reduction of light directed to near vision for large apertures is much more important than reduction of intermediate vision. Designing according to this principle ensures physiological efficiency of light in addition to technical light efficiency. Further, intermediate vision can be distinguished to an even greater extent. For larger pupils, less light in the higher range of intermediate vision can be used. The desired intensity distribution to each distance for a fully multifocal lens is mostly dictated by human physiology.

Accordingly, there is a need for an improved ophthalmic lens that utilizes the advantages of smooth diffractive gratings without discontinuities, with usable orders on both sides of the zeroth order, and where each lens adheres to physiologically dictated design principles to be able to provide a an assemble of a pair of lenses that will together be able to provide fully continuous vision for certain lighting conditions.

### OBJECTS OF THE PRESENT INVENTION

Primary object of the present invention is to provide a pair of ophthalmic multifocal aphakic lenses to be worn simultaneously by a user, said lenses having a light transmissive lens body and a diffractive profile configured to operate as a wave splitter.

Another object of the present invention is to provide a pair of ophthalmic multifocal aphakic lenses to be worn simultaneously by a user, where said diffractive profile comprises useful diffractive orders that lie on both sides of the 0^{th} order.

A further object of the present invention is to provide a pair of ophthalmic multifocal aphakic lenses to be worn simultaneously by a user where said diffractive profile is located on the central 4 millimeters of said light transmissive lens body without discontinuity.

A still further object of the present invention is to provide a pair of ophthalmic multifocal aphakic lenses to be worn simultaneously by a user, both of said lenses comprising at least a lowest usable diffraction order providing far vision and a highest usable diffraction order providing near vision.

A still further object of the present invention is to provide a pair of ophthalmic multifocal aphakic lenses to be worn simultaneously by a user, wherein for both of said lenses have the highest light intensity reserved for diffraction order used for far vision in a specific aperture interval.

### BRIEF DESCRIPTION OF THE PRESENT INVENTION

In a first aspect, there is provided a pair of ophthalmic multifocal lenses that are devised for the simultaneous use of a patient, both at least comprising a focal point for far vision. Said pair of ophthalmic lenses have a light transmissive lens body comprising a diffraction grating having useful diffraction orders on both sides of the zeroth order extending concentrically in a radial direction from an optical axis of the lens body across a part of a surface of the lens body.

Said lens pair, in a second aspect of the present disclosure, comprise individual lenses that are more biocompatible and easily tunable. Whereas in at least one lens of the lens pair, said lens is configured to produce a perceptually agreeable strength of far vision restoration, both of the lenses in the lens pair are configured such that their non-far visions correspond to a particular relationship inter alia. According to at least one embodiment of the present disclosure, power that is associated with near vision is set to dominate over the power associated with intermediate vision at a lens aperture of 3 millimeters.

Present disclosure also has the marked advantage of displaying and achieving continuous ranges between each peak of the lens profile. This is, while set to be the physical case in both of the lenses in the lens pair, is further realized by tuning individual lenses such that these set of continuous ranges occur at different positions across the profiles of respective lenses that are implanted in different eyes.

Present disclosure, next to providing better vision continuity, also has another advantage, namely, in both lenses forming the lens pair, said lens profiles are configured to be smooth profiles, said profiles also having diffractive orders that are on both sides of the 0^{th} order resulting in better biocompatibility and advanced manufacturability.

### BRIEF DESCRIPTION OF THE FIGURES OF THE PRESENT INVENTION

Accompanying drawings are given solely for the purpose of exemplifying a pair of multifocal aphakic diffractive multifocal lenses worn simultaneously by a user, whose advantages over prior art were outlined above and will be explained in brief hereinafter.

The drawings are not meant to delimit the scope of protection as identified in the claims nor should they be referred to alone in an effort to interpret the scope identified in said claims without recourse to the technical disclosure in the description of the present invention.

FIG. 1 demonstrates a simplified anatomy of the human eye.

FIGS. 2a and 2b demonstrate a front and side view, respectively, of an ophthalmic multifocal aphakic intraocular lens as known in the art.

FIGS. 3a and 3b demonstrate a front and side view, respectively, of an ophthalmic multifocal aphakic intraocular lens made according to the present invention.

FIGS. 4a, 4b, and 4c demonstrate the surface profiles, less the respective refractive baseline, of three quadrifocal lenses.

FIGS. 4d, 4e, and 4f demonstrate the modelled relative intensity of the diffractive profiles in FIGS. 4a, 4b, and 4c, respectively.

FIG. 4g presents, at different pupil sizes the highest modelled relative intensity at each optical power for the respective intensities in FIGS. 4d and 4e.

FIG. 4h presents, at different pupil sizes the highest modelled relative intensity at each optical power for the respective intensities in FIGS. 4e and 4f.

FIG. 4i presents, at different pupil sizes the highest modelled relative intensity at each optical power for the respective intensities in FIGS. 4e and 4f.

FIGS. 5a and 5b demonstrate, respectively, the profile, less the refractive baseline, and the modelled relative intensity graph of a smooth sinusoidal trifocal lens.

FIG. 5c demonstrates the change in pitch as a function of radius of the diffractive lens described in FIGS. 5a and 5b.

FIGS. 5d and 5e demonstrate, respectively, the profile, less the refractive baseline, and the modelled relative intensity graph of another smooth sinusoidal trifocal lens.

FIG. 5f demonstrates the synergistic effect between the two trifocal lens profiles as shown in FIGS. 5a and 5d.

Detailed Description of the Present Invention

10 Eye
11 Cornea
12 Pupil
13 Natural crystalline lens
14 Retina
15 Posterior cavity
16 Anterior and posterior chambers
17 Far vision
18 Intermediate vision
19 Near vision
20 Optical axis
29 Optical axis
30 Ophthalmic lens
31 Lens body
32 Haptic(s)
33 Center part
34 Front surface
35 Rear surface
36 Diffraction grating
37 Optic diameter
38 Outer diameter
39 Center thickness
50 Multifocal aphakic intraocular lens
51 A first multifocal diffractive profile
52 Anterior surface
53 Posterior surface
54 Lens body
55 A second multifocal diffractive profile
56 A second multifocal diffractive profile

One important property of diffractive gratings is the distinction between symmetric and asymmetric diffraction gratings. When ascribing symmetric or asymmetric property to multifocal ophthalmic lenses, what is considered is which diffraction orders it makes use of or renders useful. Symmetric diffractive lenses utilize orders in a way that is symmetric around the 0^{th} order. Note that symmetric diffraction gratings are defined by which orders they utilize, not by the intensity of light distribution in these orders. Some symmetric diffractive lenses may be tuned so that there is a significant difference in light intensity between e.g., +1 and −1 orders, i.e. they have an unequal light distribution. A diffraction grating tuned as such would still be considered a symmetric diffraction grating. Lenses based on symmetric gratings can be trifocal, making use of order −1, 0, and +1, or pentafocal, making use of order −2, −1, 0, +1, and +2. Such symmetric gratings can be sinusoidal or non-sinusoidal. A commonly known non-sinusoidal symmetric grating is the binary grating. However, gratings not making use of the 0^{th} order can also be considered symmetric. Specifically, the symmetric case of a grating making use of the four order −2, −1, +1, and +2 can, in some cases, be useful for ophthalmic lenses.

The vast majority of ophthalmic diffractive trifocal lenses make use of sawtooth profiles. Combining sawtooth profiles of two bifocal diffractive lenses to achieve trifocality is known in the art. This results in diffractive lenses with the usable orders arranged asymmetrically with respect to the 0^{th} order, e.g. a trifocal lens might make use of orders 0, +1, and +2 orders or 0, +2, and +3. Such diffraction gratings are henceforth referenced as asymmetric gratings. But there are also asymmetric gratings that make use of focal points on both sides of the zeroth order. Such gratings can have discontinuities and be sawtooth-like, or they can alternatively be sinusoidal gratings without any discontinuities.

The highest possible diffraction efficiency for most useful intensity distribution for diffractive multifocal lenses with an odd number of foci, including trifocal lenses, is provided by smooth sinusoidal surfaces with usable orders symmetrically arranged around the 0^{th} order.

When comparing diffractive surfaces, an important factor is the diffractive efficiency. Diffraction efficiency is a measure of how much of the optical power is directed into the desired diffraction orders, or, when referring to diffractive lenses in particular, how much of the optical power is directed into the desired focal points. For bifocal lenses, where the surface of the lens body is optimized to provide as good a vision as possible at two distinct distances, the highest possible diffraction efficiency is reached by using the principles of a phase-matched Fresnel lens, which makes use of a sawtooth or jagged type diffraction pattern. Reference is made to the publication “Refractive and diffractive properties of planar micro-optical elements”, by M. Rossi et al., in Applied Optics Vol. 34, No. 26 (1995) p. 5996-6007, which is herein incorporated by reference.

It can be advantageous to first consider linear phase grating since that field has a well-developed theory and can be utilized for diffractive lenses. It is accordingly one way of calculating the diffractive unit cell to be used. For the special case of a trifocal linear grating with an equal intensity distribution to each order, it is shown specifically that the optimal solution is a structure without sharp edges in the publication “Analytical derivation of the optimum triplicator”, by F. Gori et al., in Optics Communication 157 (1998), p. 13-16, which publication is herein incorporated by reference.

The publication “Theory of optimal beam splitting by phase gratings. I. One-dimensional gratings”, by L. A. Romero and F. M. Dickey, in Journal of the Optical Society of America Vol. 24, No. 8 (2007) p. 2280-2295, which publication is herein incorporated by reference, discloses this more generally, proving that at the very least that optimal gratings for equal splitting into odd number of orders have continuous profiles. This latter paper provides the mathematical tools to find the optimal linear phase grating for any given set of target orders and any given intensity distribution among those target orders. The optimal grating is defined as the linear diffraction grating with the highest diffraction efficiency for the specified intensity distribution. It is noted that the publications by Gori et al. and Romero et al. discuss linear phase gratings only with the intent of creating beam splitters. By treating the x-axis of the linear grating as the r² space of a diffractive lens, any such linear phase can be turned into a lens. This optimization theory is one of several good ways to find a way to start developing a lens grating. However, optimizing for the highest diffraction efficiency is not always the best option for a diffractive unit cell to be used in a grating, there are important effects specific for lenses not taken into account by optimization of linear phase gratings, optimizing for these effects can be advantageous when designing lenses according to the present invention. It is demonstrated, according to the present disclosure, that if low height is seen as a desirable trait for a diffractive grating, then the cosine-half step grating can in certain cases be strictly better than corresponding optimized grating. Additionally, the known optimization process does not take into account the dramatic effect of horizontal shifting of diffractive gratings in diffractive lens designs. To find the actual, final diffractive unit cell for optimum performance one should rely on a combination Fourier modelling and actual manufacturing followed by measurements.

There are different ways to calculate and tune diffractive lenses having useful orders on both sides of the 0^{th} order in the art. One way is to use optimized linear grating transformed into diffractive lenses, as described above and in further detail PCT/EP2019/080758. One early example of a lens based on a symmetric diffractive grating is the 7-focal lens described in the paper by Golub et al., titled “Computer generated diffractive multi-focal lens” published in Journal of modern optics 39, no. 6 (1992): 1245-1251. As a continuation of this, additional embodiments in the already mentioned Osipov 2015 study as well as the study published in 2012 by Osipov et al. called “Fabrication of three-focal diffractive lenses by two-photon polymerization technique” published in Applied Physics A 107, no. 3 (2012): 525-529. In these papers trifocal, symmetric lenses made by modifications to a sinus grating are disclosed. A different approach is also disclosed in U.S. Pat. No. 5,760,871A and IL104316, where a so called asymmetric super Gaussian formula is used to design trifocal gratings with unequal intensity distribution. Yet another method is the one described in WO2020053864A1, where the Gerchberg-Saxton iterative algorithm is used to design the surface profile of a pentafocal (having five focal points) lens with a symmetric diffraction grating. How to construct a proper trifocal lens based on a binary was disclosed in WO9411765.

The lens according to the present invention is an ophthalmic lens comprising at least a refractive baseline and a diffractive grating super positioned on to the refractive baseline, arranged so that, for a design wavelength, orders on both sides of the 0^{th} order are made usable for a user of the lens.

A strong far vision is the typical criterion to ascertain the success of cataract surgery. This is because a strong far vision is important for all apertures. In this document there is a lot of specific discussion of lens performance at different apertures. For sake of simplicity of text, the apertures and pupil sizes that are all defined in the anterior lens plane, assuming an average human eye. But to be clear, the corresponding pupil sizes are larger, the exact sizes of which will differ slightly from person to person. In the average human eye, a 2 mm aperture in the lens plane corresponds to a 2.35 mm pupil diameter, 3 mm in the lens plane corresponds to 3.515 mm, 4.5 mm to 5.28 mm, and 6 mm to 7.04 mm.

One important aspect of the present invention is tuning of the intensity distribution as a function of the lens aperture. The eye has a much larger depth of field at pupil sizes that are smaller, due to the pinhole effect. Pupil size, not being solely dependent on the pupillary light reflex, is also dependent on the accommodation reflex, which causes the pupil not sufficiently enlarging while focusing on objects of closer proximity. Because of this it often advantageous to shift light from near vision to far vision for larger pupil sizes, but also to prioritize intermediate vision over near vision for larger apertures, and even to remove or spread light from near vision even when it cannot be redistributed to other usable gratings. In the specific case of a quadrifocal lens it can be advantageous to shift light intensity from the +1^{st} order to the 0^{th} order. The intermediate distance often corresponds to the +1^{st} order, but other configurations are possible. Decreasing the intensity of the near vision is partly done to minimize problems with halo.

For small pupil sizes the pinhole effect is important to consider. A constriction of the pupil increases the depth of focus of the lens, for tiny pupils this effect generally provides a relatively good vision at all distances even with a lens that is providing only a single focus. Many modern multifocal- and enhanced depth-of-focus (EDOF) lenses takes advantage of this effect by allowing the light provided by the lens to be dominated by intermediate or near vision. The argument is that if this is provided in the center of the lens it will work well enough for the user in photopic conditions, because of large depth of field for tiny apertures, while this intensity provided for near and/or intermediate vision can be of use especially for mesopic conditions with slightly larger pupil sizes. However, the addition of near and intermediate powers is important for mesopic conditions to enable viable vision for most ranges. Usually, it is desirable in mesopic conditions to keep the near vision stronger than the intermediate vision to provide a good reading capability without the use of glasses, but in scotopic vision the near vision stops being useful and can instead have a deleterious effect.

In the present document no physical measurements are included, only modelled light intensity distributions are. However, when measurements of physical lenses are discussed in this document, what is referred to are measurements with a physical optical bench using Eye model 1 according to ISO 11979-2. Eye model 1 uses a neutral cornea. Eye model 1 can be used to measure either the intensity or the Through Focus Modulation Transfer Function (MTF). The MTF is always measured at some specific frequency, measured line pairs per millimeter (lp/mm). It is common to compare MTF values at 50 lp/mm or 100 lp/mm.

The solutions to the problem that this is addressed in this document are all concerned with how to make two complimentary lenses with relatively similar diffractive functionality and intensity distribution, but that nevertheless provides different light distributions in a way that the combination provides a good continuity of vision.

It has been observed that any given diffractive pattern provides not only different light intensities to the diffractive peaks proper, but the intensity troughs between the diffraction peaks vary significantly between different configurations of diffractive profiles. It is observed that especially the position of diffractive profile with regards to the central part of the lens (that coincides with the optical axis) is of great importance for finding different useful configurations. Further, to create continuous vision between the focal points defined by the diffraction orders it is also very important for to inspect the optical power for respective diffraction order at different aperture sizes.

A note on the terms diffraction grating and diffractive profile is in place here: A diffractive profile as discussed in this document always contain a regular or mostly regular diffraction grating, arranged for well-formed diffractive lenses. The term diffraction profile is used to refer to the physical diffractive grating implemented into a specific lens.

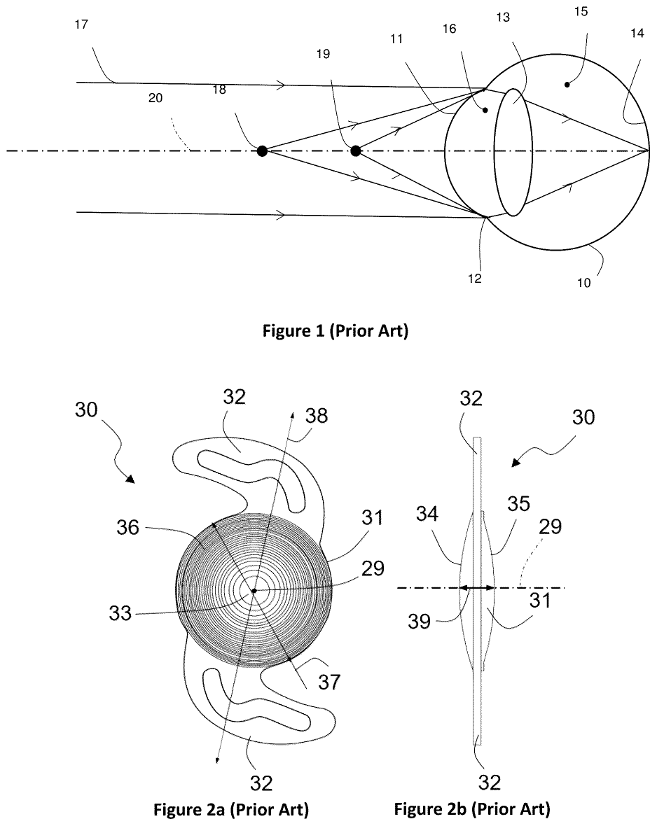

FIG. 1 shows, in a simplified manner, the anatomy of the human eye 10, for the purpose of illustrating the present disclosure. The front part of the eye 10 is formed by the cornea 11, a spherical clear tissue that covers the pupil 12. The pupil 12 is the adaptable light receiving part of the eye 10 that controls the amount of light received in the eye 10. Light rays passing the pupil 12 are received at the natural crystalline lens 13, a small clear and flexible disk inside the eye 10, that focuses light rays onto the retina 14 at the rear part of the eye 10. The retina 14 serves the image forming by the eye 10. The posterior cavity 15, i.e. the space between the retina 14 and the lens 13, is filled with vitreous humour, a clear, jelly-like substance. The anterior and posterior chambers 16, i.e. the space between the lens 13 and the cornea 11, is filled with aqueous humour, a clear, watery liquid. Reference numeral 20 indicates the optical axis of the eye 10.

For a sharp and clear far field view by the eye 10, the lens 13 should be relatively flat, while for a sharp and clear near field view the lens 13 should be relatively curved. The curvature of the lens 13 is controlled by the ciliary muscles (not shown) that are in turn controlled from the human brain. A healthy eye 10 is able to accommodate, i.e. to control the lens 13, in a manner for providing a clear and sharp view of images at any distance in front of the cornea 11, between far field and near field.

Ophthalmic or artificial lenses are applied to correct vision by the eye 10 in combination with the lens 13, in which cases the ophthalmic lens is positioned in front of the cornea 11, or to replace the lens 13. In the latter case also indicated as aphakic ophthalmic lenses.

Multifocal ophthalmic lenses are used to enhance or correct vision by the eye 10 for various distances. In the case of trifocal ophthalmic lenses, for example, the ophthalmic lens is arranged for sharp and clear vision at three more or less discrete distances or focal points, often including far intermediate, and near vision, in FIG. 1 indicated by reference numerals 17, 18 and 19, respectively. Far vision is in optical terms when the incoming light rays are parallel or close to parallel. Light rays emanating from objects arranged at or near these distances or focal points 17, 18 and 19 are correctly focused at the retina 14, i.e. such that clear and sharp images of these objects are projected. The focal points 17, 18 and 19, in practice, may correspond to focal distances ranging from a few meters to tens of centimeters, to centimeters, respectively. Usually, ophthalmologists choose lenses for the patients so that the far focus allows the patient to focus on parallel light, in the common optical terminology it is that the far is focused on infinity. Ophthalmologists will, when testing patients, commonly measure near vision as 40 cm distance from the eyes and intermediate vision at a distance of 66 cm, but other values can be used.

The amount of correction that an ophthalmic lens provides is called the optical power, OP, and is expressed in Diopter, D. The optical power OP is calculated as the inverse of a focal distance f measured in meters. That is, OP=1/f, wherein f is a respective focal distance from the lens to a respective focal point for far 17, intermediate 18 or near vision 19.

FIG. 2 generally demonstrates a multifocal ophthalmic aphakic intraocular lens known in the art. Diffractive lenses for ophthalmology applications make use of a combination of a diffractive grating and a refractive lens body.

FIG. 2a shows a top view of a typical ophthalmic multifocal aphakic intraocular lens 30, and FIG. 2b shows a side view of the lens 30. The lens 30 comprises a light transmissive circular disk-shaped lens body 31 and a pair of haptics 32, that extend outwardly from the lens body 31, for supporting the lens 30 in the human eye. Note that this is one example of a haptic, and there are many known haptic designs. The lens body 31 has a biconvex shape, comprising a center part 33, a front or anterior surface 34 and a rear or posterior surface 35. The lens body 31 further comprises an optical axis 29 extending transverse to front and rear surfaces 34, 35 and through the center of the center part 33. Those skilled in the art will appreciate that the optical axis 29 is a virtual axis, for the purpose of referring the optical properties of the lens 30. The convex lens body 31, in a practical embodiment, provides a refractive optical power of about 2D to 35D, with around 20D to 22D being the most common.

In the embodiment shown, at the front surface 34 of the lens body 31 a periodic light transmissive diffraction grating or relief 36 is arranged, comprised of rings or zones extending concentrically with respect to the optical axis 29 through the center part 33 over at least part of the front surface 34 of the lens body 31. The diffraction grating or relief 36 provides a set of diffractive focal points. Although not shown, the diffraction grating or relief 36 may also be arranged at the rear surface 35 of the lens body 31, or at both surfaces 34, 35. In practice, the diffraction grating 36 is not limited to concentric circular or annular ring-shaped zones, but includes concentric elliptic or oval shaped zones, for example, or more in general any type of concentric rotational zone shapes.

In practice the optic diameter 37 of the lens body 31 is about 5-7 mm, while the total outer diameter 38 of the lens 30 including the haptics 31 is about 12-14 mm. The lens 30 may have a center thickness 39 of about 1 mm. In the case of ophthalmic multifocal contact lenses and spectacle or eye glass lenses, the haptics 32 at the lens body 31 are not provided, while the lens body 31 may have a plano-convex, a biconcave or plano-concave shape, or combinations of convex and concave shapes. The lens body may comprise any of Hydrophobic Acrylic, Hydrophilic Acrylic, Silicone materials, or any other suitable light transmissive material for use in the human eye in case of an aphakic ophthalmic lens.

Those skilled in the art will appreciate that the lens body 31 may comprise a plano-convex, a biconcave or plano-concave shape, and combinations of convex and concave shapes or curvatures (not shown).

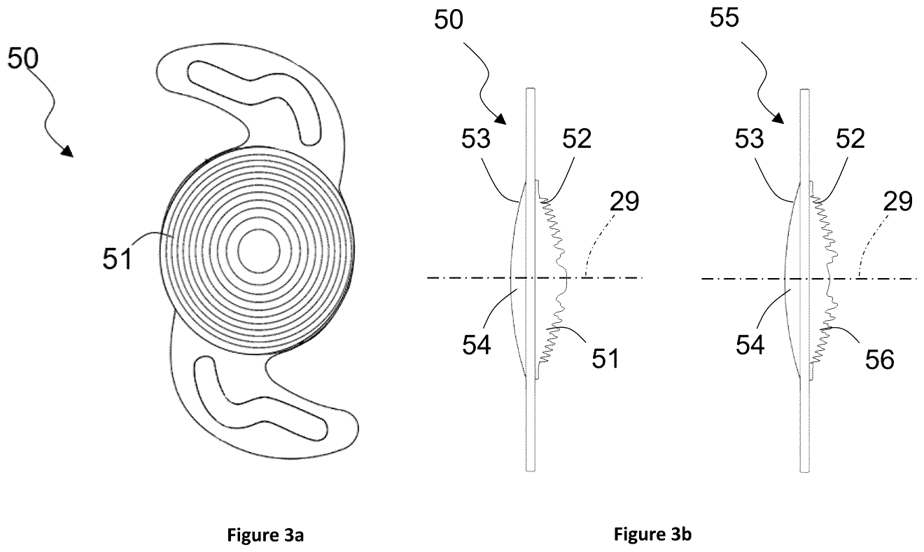

FIG. 3a shows a top view of a first ophthalmic multifocal aphakic intraocular lens 50. This is a simplified presentation, representing any of the two lenses in the lens pair that together work in accordance with the present invention. FIG. 3b shows a side view of the lens 50 and of a second multifocal aphakic intraocular lens 55. The difference over the prior art, exemplified in FIG. 2 are in the combination of different diffractive optics, the lens 50 having a first multifocal diffractive profile 51, and the lens 55 having a a second multifocal diffractive profile 56. These two different diffractive profiles are arrange to work together synergistically when used with simultaneously in the two eyes of a user. The lens body 54 has a biconvex shape, comprising a front or anterior surface 52 and a rear or posterior surface 53. The skilled person would know that for some embodiments one or both of the anterior surface 52 and the posterior surface 53 might be concave or planar, depending on the refractive baseline needed for a specific application. When constructing and analyzing the lens the full anterior surface of each lens is a summation of a diffractive profile and a refractive baseline. The refractive baseline is substantially monofocal and any substantially monofocal design can be used. It is of course well-known that any monofocal design takes into consideration both the anterior and posterior sides. The point being that any useful monofocal design can be used to define the refractive baselines of the current invention. The diffractive profiles 51 and 56 are substantially continuous and both make use of orders on both sides of the 0^{th} order, but lens pairs according to the patent can make use of an array of order combinations. The number of focal points might be 3, 4 or a higher number, such as 4, 5, or 7. One useful configuration is the one using the diffractive order (−1, 0, +2). Some advantageous configurations makes use of diffractive orders that are not symmetrically arranged around the 0^{th} order, for example can it be advantageous to use the set of orders (−1, 0, +1, +2) or (−2, −1, 0, +1, +2, +3). Note that the anterior surface 52 is drawn with a refractive baseline with larger radius, i.e. lower optical power, than typical, this is done purely for illustrative purposes, to keep the diffractive component visible. It should also be noted that the refractive baselines of the two lenses 50 and 55 can be different from each other.

It is obvious to the skilled person that this is only one possible configuration. It is possible, for example, to place the diffractive part of the optics on the posterior side, to distribute the diffractive grating over both sides.

The shape or height profile of the refractive baseline for any of the portions of the lens may be selected among a plurality of continuous refraction profiles known from monofocal lenses, such as spherical or any variant of aspherical profiles. Most modern intraocular monofocal lenses are aspherical with the asphericity chosen to either be neutral and thus causing no further aberration in the eye, or they are purposefully induced to, given the optics of an average eye to exhibit negative spherical aberration to neutralize, fully or partly, the positive spherical aberration that is usually present in the human cornea. Those choices should all be seen as different ways to create monofocal bases. The invention described in this patent can be incorporated with any such monofocal base. The manufacturing of refractive of diffractive surfaces can be carried out by any of laser micro machining, diamond turning, 3D printing, or any other machining or lithographic surface processing technique.

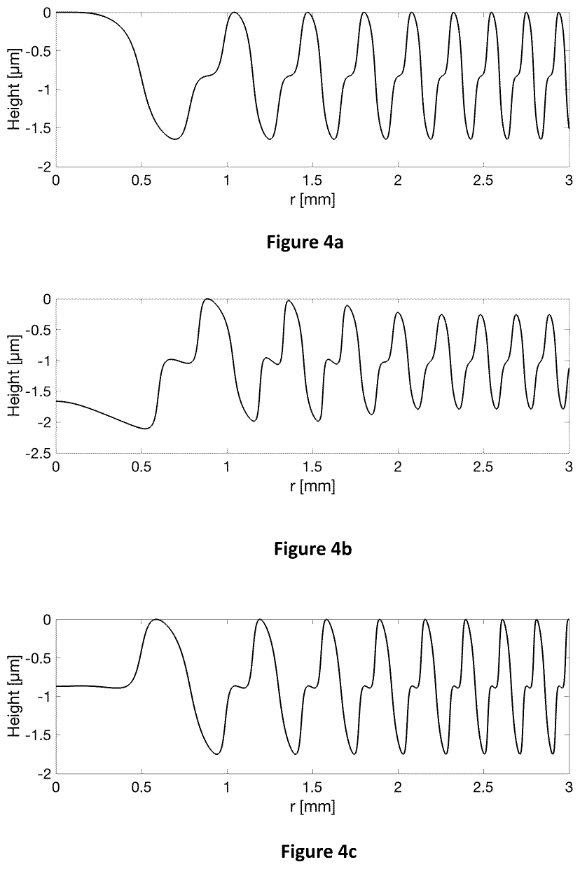

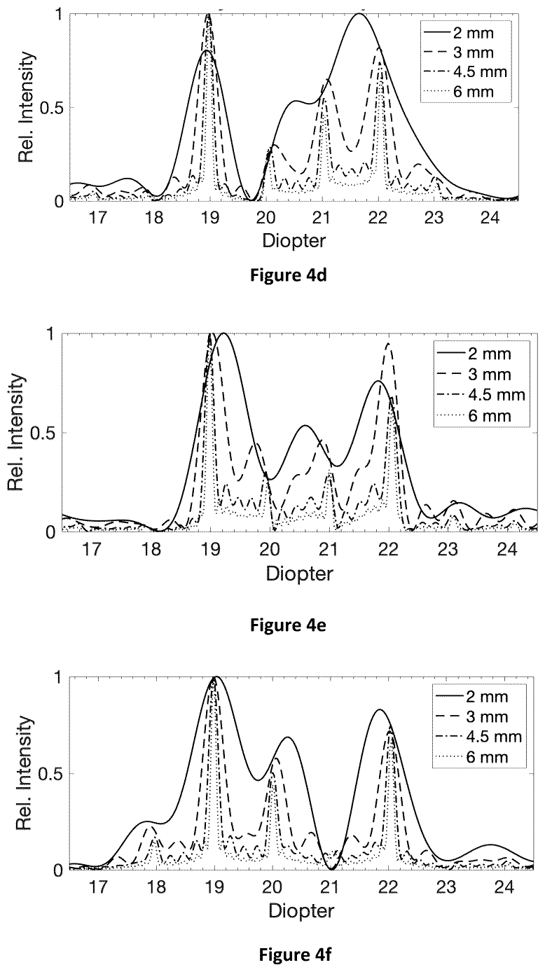

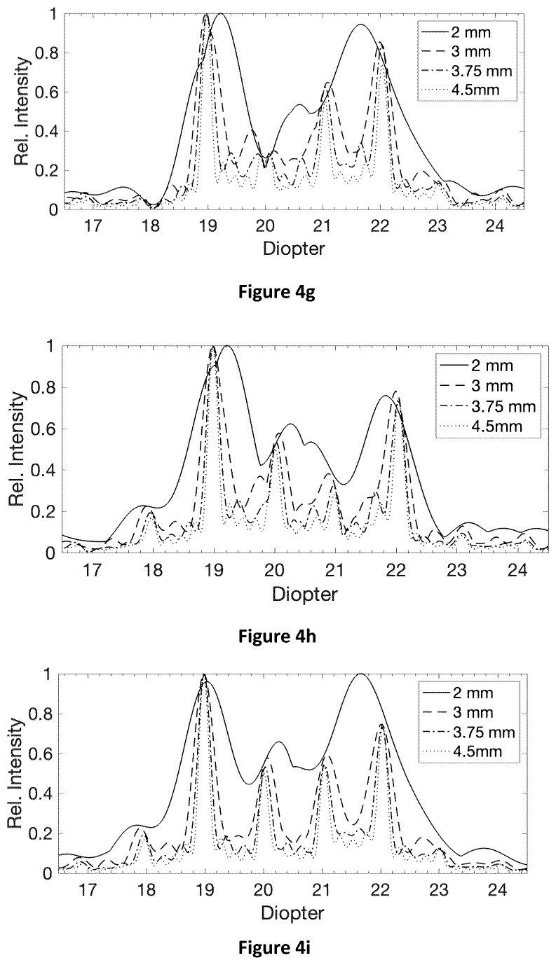

FIGS. 4a, 4b, and 4c each show a lens profile for a lens made according to the present invention, shown here less the refractive baseline. These profiles are calculated, and later modelled for, a refractive index of 1.5359. All three diffractive profiles make use of diffractive unit cells with four main diffractive orders. The diffractive profiles are here shown from the center of the lens that coincides with the optical axis and out to the edge of optic surface at around a radius of 3 mm. The main difference, but not the only one, between the three profiles is different horizontal shift for each profile, defining the three of the main types of very useful quadrifocal lenses that we have found.

FIGS. 4d, 4e, and 4f each show the modelled relative intensity distribution at different lens apertures of the lens profiles in FIGS. 4a, 4b, and 4c, respectively.

The lens profile in FIG. 4a places a diffractive ring close to centered over the optical axis, a configuration that has four diffractive orders, −1, 0, +1, and +2, and as is shown by FIG. 4d it is providing vision for a user at, respectively, around 19.0D, 20.1, 21.1D, and 22.0D. −1^{st} order corresponds to far vision, the near vision is addressed by the +2nd order at an addition of 3D, which is above, but close to the lower limit of near addition for clinical interest. The +1^{st} order provides an addition of 2D, which is close to the ideal position of an intermediate addition. The 0^{th} order is at 1D addition over the far vision, which is well below intermediate vision, but it can certainly help to increase the total depth of focus. The repeated diffractive unit cell in FIG. 4a has a higher peak that is, in this case, 1.65 μm peak-to-peak, on each main peak there is a soft shoulder that faces the center of the lens. This configuration of the sinusoidal, or smooth, quadrifocal grating places a lowest intensity trough between the −1^{st} and the 0^{th} order, and can be referred to as the Intermediate-near configuration. This creates a configuration that is very suitable for ophthalmic lenses for users who want to be spectacle free. This configuration provides a strong, but isolated, far vision and a rather continuous vision for near vision, intermediate vision and further. For 2 mm and for 3 mm lens apertures there is a very high degree of continuous vision for the whole range of far to near vision. For larger apertures more light intensity goes into far vision, as desired. The deepest intensity trough at a 2 mm lens aperture is between −1^{st} order and 0^{th} order. In FIG. 4d it can be seen that the power of the far vision is substantially constant with increasing aperture, while the power for near vision increases, and with that increases also the distance in power between near and far vision. In this lens this is due to the inherent properties of the diffractive grating.

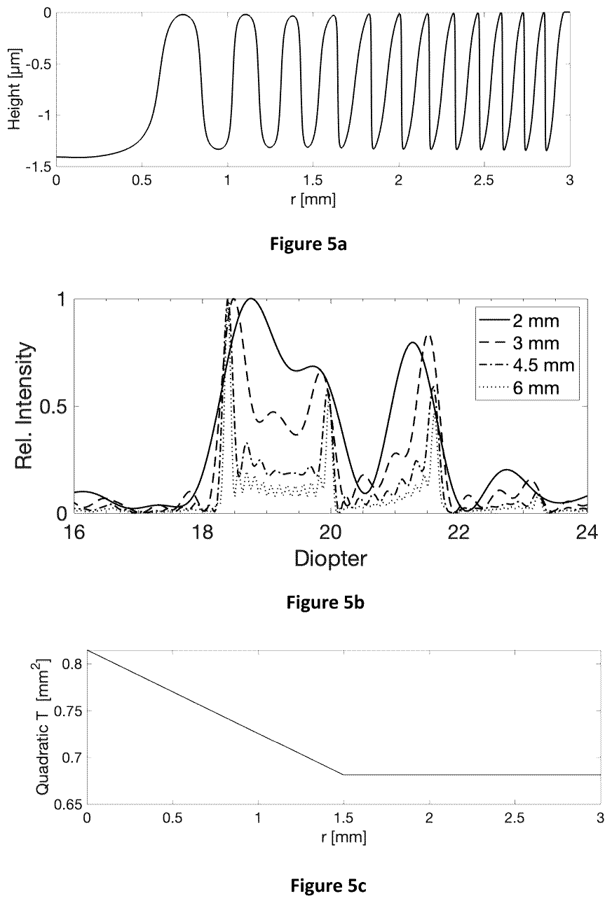

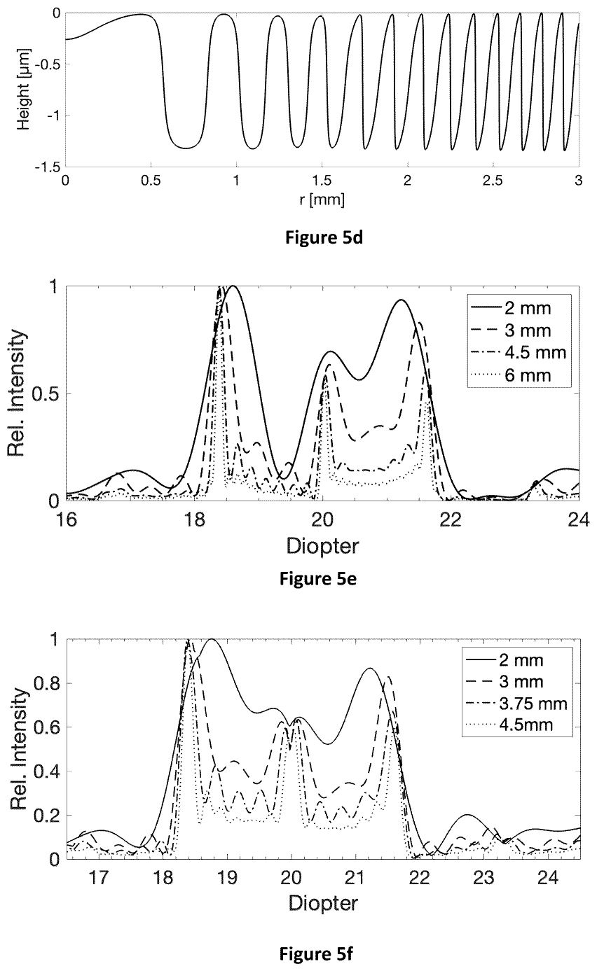

The lens profile in FIG. 4b places a trough of the diffractive ring close to centered over the optical axis, a configuration that has four diffractive orders, −1, 0, +1, and +2, and as is shown by FIG. 4e it is providing vision for a user at, respectively, around 19.0D, 19.9, 21.0D, and 22.1D. This lens functions similarly to the one described in FIGS. 4a and 4d, however, this configuration of the sinusoidal, or smooth, quadrifocal grating places a lowest intensity trough between the 0^{th} and the +1^{st} order and can be referred to as the Broad far configuration. The lowest intensity point is not as low as the one in FIG. 4d. For 2 mm and 3 mm lens apertures this lens provides continuous vision mostly between far and near vision. This version, as well, creates a configuration that is very suitable for ophthalmic lenses for users who want to be spectacle free. This configuration provides a strong far vision that is broadened by the 0^{th} order. Intermediate and near vision are also provided, but the continuity of vision is less good than in the Intermediate-near configuration. It can be seen in FIG. 4b that the unit cell for this lens changes significantly as a function of the lens aperture. This is done to provide the desired aperture-dependent tuning. One very advantageous feature that was found out while exploring these diffractive profiles is that when tuning the grating to provide more intensity to the far vision (i.e. light corresponding to the lowest diffraction order) the grating became lower. For a trifocal sinusoidal grating increase of intensity to far vision requires a higher profile. This is a significant advantage as it allows for a lower grating at the periphery of the lens. High diffractive pattern at the periphery of the lens increases risk for dysphotopsia. This is effect is very visible here. Additionally, this Broad far design is constructed so that the grating pitch, measured in quadratic space, from the center to a lens diameter of 3 mm decreases with increasing diameter. This increases the continuity between the peaks proper. This technique is further discussed and explained in relation to FIGS. 5a, 5b, and 5c. The deepest intensity trough at a 2 mm lens aperture is between 0^{th t} order and +1^{st} order. In FIG. 4e it can be seen that the distance in diopter between the far and near peaks increase with increasing aperture. This effect is in this case to a large degree due to the change of grating pitch as a function of aperture size.

The lens profile in FIG. 4c places the soft shoulder of the diffractive grating close to centered over the optical axis, a configuration that has four diffractive orders, −1, 0, +1, and +2, and as is shown by FIG. 4f it is providing vision for a user at, respectively, around 19.0D, 20.1, 21.0D, and 22.1D. However, the +1^{st} order is in this configuration severely suppressed because of the position at the center of the lens. The lens functions similarly to the one described in FIGS. 4a and 4d and FIGS. 4b and 4e, however, this configuration of the sinusoidal, or smooth, quadrifocal grating has a lowest intensity point almost coinciding with the +1^{st} order, rendering the almost a trifocal lens. It is even the case that the 2^{nd} order around 18D has a higher intensity than the +1^{st} order. This version creates a configuration that does provide good far and near vision and some intermediate vision, but there is no correctly placed order to provide strong intermediate vision. To our knowledge no lens with similar characteristic has even been sold (or proposed), but a lens like this would act as a bifocal lens for near and far vision, but with what is essentially an extended far vision. This is dubbed the far-intermediate configuration for sake of nomenclature. This unusual distribution could be very useful to use in combination with a more conventional light distribution. The deepest intensity trough at a 2 mm lens aperture is right between 0^{th} order and the +2^{nd} order. In FIG. 4f it can be seen that the power of the far vision as well as that of the near vision slightly changes with increasing aperture so that difference in power increases. In this lens this is due to the inherent properties of the diffractive grating. It would be possible to increase this effect by changing the grating pitch in the center of the lens, if it was desired to heighten the lowest intensity points.

FIGS. 4g, 4h, and 4i are all made to illustrate the varying synergistic effects between different lens pairs. For each point on the horizontal axis the highest modelled absolute intensity among the two lenses in the pair is chosen. This is done separately for each of the four apertures. The resulting data was then plotted as relative intensity to illustrate the weakness and strength of each pair. This is a way to illustrate, in a relative way, how good vision is available at each distance for at least one eye.

FIG. 4g presents, at different pupil sizes the highest modelled relative intensity at each optical power for the respective intensities in, on the one hand the intermediate-near configuration (illustrated in FIGS. 4a and 4d) and on the other hand the broad far configuration (illustrated in FIGS. 4b and 4e). One way to compare combined diffraction profiles is to look at the profile height at the center compared with the maximum crest-to-trough height in that profile. The diffractive profile in FIG. 4a has a center height that is at 100% of the maximum crest-to-trough height. The diffractive profile in FIG. 4b is at 21%, leading to a difference of 79 percentage points. All information taken together this is a very advantageous combination of lenses, with two lenses that taken on their own are very suitable multifocal lenses and with an overall very suitable intensity distribution with very broad far vision and a very good continuous vision of intermediate and near.

FIG. 4h presents, at different pupil sizes, the highest modelled relative intensity at each optical power for the respective intensities in, on the one hand the Broad far configuration (illustrated in FIGS. 4b and 4e) and on the other hand the Far-intermediate configuration (illustrated in FIGS. 4c and 4f). The diffractive profile in FIG. 4b has a center height that is at 21% of the maximum crest-to-trough height. The diffractive profile in FIG. 4c is at 50%, leading to a difference of 29 percentage points. This lens pair provides good far and intermediate vision as well as good continuous vision, but the intensity distribution in the range between far and near vision is not ideal.

FIG. 4i presents, at different pupil sizes the highest modelled relative intensity at each optical power for the respective intensities in, on the one hand the Broad far configuration (illustrated in FIGS. 4a and 4d) and on the other hand the Far-intermediate configuration (illustrated in FIGS. 4c and 4f). The diffractive profile in FIG. 4a has a center height that is at 100% of the maximum crest-to-trough height. The diffractive profile in FIG. 4c is at 50%, leading to a difference of 50 percentage points. This lens pair has a combined intensity distribution that is excellent and very even. The two lenses could easily be tuned to fulfil product specific needs on the intensities of any orders.

FIG. 5a illustrates the profile of a sinusoidal trifocal lens, less the refractive baseline. This profile is calculated, and later modelled for, a refractive index of 1.525. The lens profile in FIG. 5b places the trough of the diffractive grating close to centered over the optical axis, a configuration that has three diffractive orders, −1, 0, and +1, corresponding to far, intermediate, and near vision, respectively. As is shown by FIG. 5b it is providing vision for a user at, respectively, around 18.4D, 20.0, and 21.5D. There is good continuous vision between the far vision and the intermediate. The deepest intensity trough at a 2 mm lens aperture is right between 0^{th} order and the +1^{st} order. Overall, this lens is light efficient and has a high degree of continuity, but with one significant trough. This lens has greater continuity than a typical trifocal sinusoidal lens due to a small change in the pitch of the grating. One feature of this lens is that to further spread the light intensity between the diffractive peaks proper the grating pitch is varied.

FIG. 5c illustrates the change in pitch of the diffractive grating as a function of lens radius of the diffractive profile in FIG. 5a, as well as for the lens profile in FIG. 5d. The pitch is expressed in quadratic space. In a typical diffractive lens, the grating pitch is static over the whole diameter. Here, however, the pitch decreases with increasing lens apertures from the center of the lens out to approximately an aperture of 3 mm (1.5 mm from the optical axis). This causes the diffractive power to decrease with increasing aperture. The results can be easily understood from FIG. 5b, as the power of the near and the far, respectively, are close to the 0^{th} order for small apertures than for larger. It turns out that this is a very effective way of increasing continuity of vision. As has been discussed in relation to FIGS. 4a, 4d, 4c, and 4f to increase continuity of vision is often useful to choose a diffractive profile with a diopter distance between far and near power that increases with increasing aperture. This is often done by horizontal shift of the chosen diffractive unit cell. However, to further increase this effect the pitch of the grating can be kept slightly higher close to the center of the lens, the pitch is then gradually decreased with increasing radius until the nominal value is reached. The lens profiles in FIGS. 5a and 5d are calculated for a refractive index of 1.525 and an assumed design wavelength, λ, of 550 nm and a target Far power, P, of 1.615D below that of the refractive base. For the period in quadratic space, T, then for this grating, Equation 1 gives:

$$T = \frac{2 λ}{P} ⇔ P = \frac{2 λ}{T} \qquad ( 1 )$$

For a standard case of diffractive lenses, this would result in a diffractive lens with static grating pitch in quadratic space of 0.681 mm². In the currently discussed lenses design made as part of the present invention, this pitch is attained at a radius of 1.5 mm. It is important to note that the change in pitch is not changed between periods but is calculated and changed at each diameter. Note that a similar change of grating pitch was used for the lens profile made according to the invention in FIG. 4b, but not for the lenses, made according to the present invention, in FIGS. 4a and 4c. There is of course a limit to which extent this can used. At some levels of power change the powers for far and near vision are not the desired ones. It is especially critical to be careful with the placement of the far vision, as a failure to provide far vision in the case of intraocular lenses is a failed surgery. However, a very important point is that small changes to power have less importance for small pupil sizes, while it is very critical to have the correct position for large pupils.

FIG. 5d illustrates the profile of a sinusoidal trifocal lens, less the refractive baseline. This profile is calculated, and later modelled for, a refractive index of 1.525. The lens profile in FIG. 5e places the peak of the diffractive grating close to being centered over the optical axis, a configuration that has three diffractive orders, −1, 0, and +1, corresponding to far, intermediate, and near vision, respectively. As is shown by FIG. 5e it is providing vision for a user at, respectively, around 18.4D, 20.0, and 21.5D.

There is good continuous vision between the intermediate vision and the near vision. The deepest intensity trough at a 2 mm lens aperture is right between 0^{th} order and the +1^{st} order. Overall, this lens is light efficient and has a high degree of continuity, but with one significant trough. The grating pitch in quadratic space is a function of the lens radius in FIG. 5c.

FIG. 5f illustrates the synergistic effect between the two trifocal lens profiles shown in FIGS. 5a and 5d. For each point on the horizontal axis the highest modelled absolute intensity among the two lenses in the pair is chosen. This is done separately for each of the four calculated apertures. The resulting data are then plotted as relative intensity to illustrate the weakness and strength of each pair. The result here is a remarkable level of continuous vision throughout the whole range between far vision and near vision. The diffractive profile in FIG. 5a has a center height that is at 0% of the maximum crest-to-trough height. The diffractive profile in FIG. 5d is at 80%, leading to a difference of 80 percentage points. This lens pair has a combined intensity distribution that is remarkably effective and very evenly spread over the usable power range.

Other variations to the disclosed examples and embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope thereof. Same reference signs refer to equal or equivalent elements or operations.

According to an aspect of the present disclosure, an assembly comprising a pair of multifocal ocular aphakic lenses to be worn simultaneously by a user is proposed.

According to an aspect of the present disclosure, said lenses have a light transmissive lens body with an optical axis and a refractive baseline that extends over at least a part of the lens body, and a diffractive profile configured to operate as an optical wave splitter extending concentrically in radial direction, superpositioned onto at least one part of the refractive baseline.

According to another aspect of the present disclosure, for both lenses, said diffractive profile is comprised in the central 4 millimeters without discontinuities, with useful diffractive orders on both sides of a 0th diffractive order.

According to another aspect of the present disclosure, both lenses comprise a lowest usable diffraction order that provide far vision and a highest usable diffraction order that provides near vision.

According to yet another aspect of the present disclosure, for both lenses the provided light intensity of the diffraction order corresponding to near vision is configured to be higher than that of any diffraction order in between the highest and lowest usable orders for lens apertures in the range of 2 to 3 millimeters.

According to yet another aspect of the present disclosure, diffractive profiles in said two lenses are arranged such that the difference in profile height between said two lenses at the position of the lens coinciding with the optical axis, profile height being measured as a percentage of maximum crest-to-trough height in each lens, is configured to be greater than 45 percentage points.

According to yet another aspect of the present disclosure, for one of the lenses in the lens pair, the lowest intensity trough placed at a power between far and near peaks that are measured at a 2 millimeter lens aperture is placed between the order reserved for far vision and the second lowest usable order, and, for the other lens, the lowest intensity trough is configured to be placed elsewhere.

According to yet another aspect of the present disclosure, for both lenses in the lens pair, the provided light intensity of the diffraction order corresponding to far vision is configured to be higher than any other diffractive order for any lens aperture above 3 millimeters.

According to yet another aspect of the present disclosure, for at least one lens in the lens pair, the entirety of the power range between the lowest and highest diffraction orders, the MTF is configured to be greater than 0.08, when measured at 50 line pairs per millimeter at each power.

According to yet another aspect of the present disclosure, all usable diffraction orders in both lenses in said lens pair are identical.

According to yet another aspect of the present disclosure, for both lenses in said lens pair the difference in diopter between intensity peaks of far and near vision is larger at a 2 mm aperture than at a 3 mm aperture.

According to yet another aspect of the present disclosure, at least one of the two lenses in the lens pair comprise a diffraction profile constructed such that the period pitch, measured in quadratic space, is configured to decrease with increasing aperture in at least some predetermined lens aperture range.

1. An assembly comprising a pair of multifocal ocular aphakic lenses to be worn simultaneously by a user, said lenses having a light transmissive lens body with an optical axis and a refractive baseline that extends over at least a part of the lens body, and a diffractive profile configured to operate as an optical wave splitter extending concentrically in radial direction, superpositioned onto at least one part of the refractive baseline wherein
for both lenses, said diffractive profile is comprised in the central 4 millimeters without discontinuities, with useful diffractive orders on both sides of a 0^{th} diffractive order,
both lenses comprise a lowest usable diffraction order that provide far vision and a highest usable diffraction order that provides near vision; and,
for both lenses the provided light intensity of the diffraction order corresponding to near vision is configured to be higher than that of any diffraction order in between the highest and lowest usable orders for lens apertures in the range of 2 to 3 millimeters.

2. The assembly comprising a pair of multifocal ocular aphakic lenses to be worn simultaneously by a user as set forth in claim 1 wherein diffractive profiles in said two lenses are arranged such that the difference in profile height between said two lenses at the position of the lens coinciding with the optical axis, profile height being measured as a percentage of maximum crest-to-trough height in each lens, is configured to be greater than 45 percentage points.

3. The assembly comprising a pair of multifocal ocular aphakic lenses to be worn simultaneously by a user as set forth in claim 1 wherein for one of the lenses in the lens pair, the lowest intensity trough placed at a power between far and near peaks that are measured at a 2 millimeter lens aperture is placed between the order reserved for far vision and the second lowest usable order, and, for the other lens, the lowest intensity trough is configured to be placed elsewhere.

4. The assembly comprising a pair of multifocal ocular aphakic lenses to be worn simultaneously by a user as set forth in claim 1 wherein for both lenses in the lens pair, the provided light intensity of the diffraction order corresponding to far vision is configured to be higher than any other diffractive order for any lens aperture above 3 millimeters.

5. The assembly comprising a pair of multifocal ocular aphakic lenses to be worn simultaneously by a user as set forth in claim 1 wherein for at least one lens in the lens pair, the entirety of the power range between the lowest and highest diffraction orders, the MTF is configured to be greater than 0.08, when measured at 50 line pairs per millimeter at each power.

6. The assembly comprising a pair of multifocal ocular aphakic lenses to be worn simultaneously by a user as set forth in claim 1 wherein all usable diffraction orders in both lenses in said lens pair are identical.

7. The assembly comprising a pair of multifocal ocular aphakic lenses to be worn simultaneously by a user as set forth in claim 1 wherein for both lenses in said lens pair the difference in diopter between intensity peaks of far and near vision is larger at a 2 mm aperture than at a 3 mm aperture.

8. The assembly comprising a pair of multifocal ocular aphakic lenses to be worn simultaneously by a user as set forth in claim 7 wherein at least one of the two lenses in the lens pair comprise a diffraction profile constructed such that the period pitch, measured in quadratic space, is configured to decrease with increasing aperture in at least some predetermined lens aperture range.
